(19) United States
(12) Patent Application Publication
(10) Pub. No.: US 2026/0365270 A1
(43) Pub. Date: Nov. 19, 2026

(54) INTEGRALLY THREADED COMPOSITE BOTTOM BRACKET

(71) Applicants: Thanos DRIVAS, Toronto (CA); Brandan NETO, Toronto (CA)

(72) Inventors: Thanos DRIVAS, Toronto (CA); Brandan NETO, Toronto (CA)

(73) Assignee: Bridge Bike Works Inc., Toronto, ON (CA)

(21) Appl. No.: 19/471,202

(22) PCT Filed: Mar. 28, 2024
(86) PCT No.: PCT/CA2024/050404

§ 371 Date: Sep. 30, 2025

Related U.S. Application Data
(60) Provisional application No. 63/456,309, filed on Mar. 31, 2023.

(51) Int. Cl. B62K 19/34; B29C 70/86; B29L 31/30; B62K 19/16

(52) U.S. Cl. CPC B62K 19/34; B29C 70/865; B62K 19/16; B29L 2031/3091

(57) ABSTRACT

Described herein is an integrally threaded composite part having a first structural member extending along a first plane, a second structural member extending along the first plane, a hollow inner bore located at an intersection of the first and second structural members, the hollow inner bore extending perpendicularly to the first plane, and at least one composite thread located along the interior of the hollow inner bore and integrally formed therewith. Further disclosed is a method of manufacture including wrapping at least one molding insert with a preformed fiber reinforced material, debulking the at least one molding insert, marrying the debulked fiber reinforced material with at least one preformed composite part; inserting the at least one molding insert, debulked fiber reinforced material and at least one preformed composite part into a tool assembly, and molding the at least one preformed composite part into the part mold.

### FIELD

The embodiments described herein are directed to bottom brackets of composite bicycle frames. More particularly, the embodiments are directed to a bottom bracket of a bicycle frame having an integrally threaded composite bracket molded directly into the part, and methods of assembling and manufacturing the same.

### INTRODUCTION

The following is not an admission that anything discussed below is part of the prior art or part of the common general knowledge of a person skilled in the art.

Bicycle frames are commonly constructed of composite materials. These composite materials, such as carbon fiber, and/or sometimes referred to as carbon fiber reinforced plastic (CFRP), have a lower weight and density, higher strength and stiffness, and better damping qualities than previously used metal materials.

Currently, bottom brackets of bicycle frames require an integrally threaded metal bearing, metal bearing and carrier shell, or do not have threading at all for press fit bearing methodologies within the bottom bracket that allow the crankshaft to rotate with the users pedal strokes. The bottom bracket of a bike is designed to hold bearings in order for the crank axle to rotate when the user pedals. In a now common configuration, a bearing housed in a threaded housing is tightened in place for ease of installation, service and alignment. In other configurations, the bottom bracket of the bike frame may be manufactured with a smooth bore to allow for installation of the metal bearings without threads, press fit in. Manufacturing of these carbon fiber bike frames may require either post processing to ensure a smooth press fit, or the installation of a threaded alloy sleeve into the bottom bracket of the bike frame in a manufacturing step after molding the bottom bracket by using a bonded-in insert or a thread forming or cutting process.

However, absent from the industry is a bicycle frame's bottom bracket composed entirely of a composite material, such as carbon fiber, including the threads design to accept bearings housed in threaded housings. These are commonly known at T47, though the invention disclosed herein contemplates a product and corresponding process for any type of threaded bottom bracket. The following disclosure provides a product and corresponding method for manufacturing a composite bottom bracket where the threads are produced directly into the composite during the molding process.

### SUMMARY

Various embodiments of an integrally threaded composite part, bottom bracket for a bicycle and corresponding methods are provided according to the teachings herein.

In one aspect, in accordance with the teachings herein, disclosed is an integrally threaded composite part having a first structural member extending along a first plane, a second structural member extending along the first plane, a hollow inner bore located at an intersection of the first and second structural members, the hollow inner bore extending perpendicularly to the first plane, and at least one composite thread located along the interior of the hollow inner bore and integrally formed therewith.

In another aspect, in accordance with the teachings herein, disclosed is a composite bottom bracket for a bicycle frame having a first structural member extending along a frame plane and defining a first surface and a second surface, a second structural member extending outwardly from the first structural member along the frame plane, the second structural member continuously defining the first surface and the second surface, a third structural member extending outwardly from each the first and second structural members along the frame plane, the third structural member continuously defining the first surface and the second surface, a hollow inner bore located at an intersection of the first, second and third structural members, the hollow inner bore extending from the first surface to the second surface, and composite threads located along the interior of the hollow inner bore, wherein the composite threads extend from the first surface into the inner bore and extend from the second surface into the inner bore and are integrally formed therewith.

In some examples, the hollow inner bore is adapted to operationally receive a pedal mechanism.

In some examples, each of the first, second and third structural members have a wall depth of 0.2 mm and 8.0 mm.

In some examples, the composite threads extend from each the first surface and the second surface into the inner bore along the bore axis a distance greater than the single wall depth.

In some examples, the composite threads extend from the first surface to the second surface.

In some examples, the first, second and third structural members are single walled hollow structural members.

In some examples, the first structural member extends along a first axis, the second structural member extends along a second axis, and the third structural member extends along a third axis.

In some examples, the hollow inner bore is located at an intersection of the first axis, the second axis, and the third axis.

In another aspect, in accordance with the teachings herein, disclosed is a method of manufacturing an integrally threaded composite part, the method including wrapping at least one molding insert with a preformed fiber reinforced material, the at least one molding insert defining a thread geometry, debulking the at least one molding insert and wrapped preformed fiber reinforced material to form the fiber reinforced material into the thread geometry of the at least one molding insert, marrying the debulked fiber reinforced material with at least one preformed composite part, inserting the at least one molding insert, debulked fiber reinforced material and at least one preformed composite part into a tool assembly, the tool assembly defining a part mold, the part mold having at least one bore location for receiving the at least one molding insert and debulked fiber reinforced material, and molding the at least one preformed composite part into the part mold, the at least one preformed composite part contacting and bonding to the debulked fiber reinforced material around the at least one molding insert.

In some examples, the method further includes assembling at least one preformed composite part prior to marrying the debulked fiber reinforced material, the assembly including wrapping at least one mandrel with at least one preformed composite material.

In some examples, the debulked fiber reinforced material around the at least one molding insert is married to the at least one preformed composite part by a draping ply, the draping ply placed around the debulked fiber reinforced material and bonded to the at least one preformed composite part.

In some examples, molding the at least one preformed composite part includes inflating at least one bladder to push the at least one preformed composite part into the part mold, and applying heat, a clamping force to the part mold and internal pressure to the at least one bladder.

In some examples, molding the at least one preformed composite part further includes curing the at least one preformed composite part within the part mold.

In some examples, after curing the at least one preformed composite part within the part mold, the integrally threaded composite part is cooled and removed from the part mold.

In some examples, the integrally threaded composite frame is cured for one to three hours at a temperature of 100 to 150 degrees Celsius.

In some examples, after curing, the at least one bladder is removed from the interior of the integrally threaded composite part.

In some examples, the at least one bladder is formed of a bio-degradable material.

In some examples, the at least one bladder is of a complex shape resembling the final geometry of the part mold.

In some examples, the part mold is shaped to form a bottom bracket having a first structural member extending along a first plane, a second structural member extending along the first plane, and a hollow inner bore located at an intersection of the first and second structural members, the hollow inner bore extending perpendicularly to the first plane.

In some examples, the part mold is shaped to form a part having a first structural member extending along a frame plane and defining a first surface and a second surface, a second structural member extending outwardly from the first structural member along the frame plane, the second structural member continuously defining the first surface and the second surface, a third structural member extending outwardly from each the first and second structural members along the frame plane, the third structural member continuously defining the first surface and the second surface, and a hollow inner bore located at an intersection of the first, second and third structural members, the hollow inner bore extending from the first surface to the second surface.

In some examples, the at least one molding insert and formed composite threads are inserted within the hollow inner bore locating feature of the part mold.

In some examples, the at least one molding insert and formed composite threads extend from the first surface to the second surface.

In some examples, at least two molding inserts and formed composite threads are inserted within the hollow inner bore locating feature of the part mold, the first molding insert located at the first surface and the second molding insert located at the second surface.

In some examples, a space is formed between the at least two molding inserts within the hollow inner bore locating feature, the space laminated through to form a solid bore of composite material.

In some examples, the composite material filling the space between the at least two molding inserts is removed.

In some examples, the composite material filling the space between the at least two molding inserts is not removed.

In another aspect, in accordance with the teachings herein, disclosed is a bicycle having a frame having at least one frame member made of a composite material, and at least one composite thread located within the at least one frame member and being integrally formed therewith.

In some examples, the at least one composite frame member is located along a crank axis and supports a pedal mechanism.

In some examples, the frame comprises at least two frame members made of composite material.

In some examples, the at least one composite thread is located at the intersection of the at least two frame members.

In some examples, the frame comprises at least three frame members made of composite material.

In some examples, the at least one composite thread is located at the intersection of the at least three frame members.

In another aspect, in accordance with the teachings herein, disclosed is a frame for a vehicle, having at least one frame member made of a composite material, and at least one composite thread located within the at least one frame member and being integrally formed therewith.

In some examples, the vehicle is a bicycle.

In some examples, the at least one composite frame member is located along a crank axis and supports a pedal mechanism.

In some examples, the at least one composite thread extends inwardly from an outer surface of the at least one frame member.

In another aspect, in accordance with the teachings herein, disclosed is an integrally threaded composite part having a first structural member, and composite threads integrally formed in the structural member and extending inwardly from an outer surface of the structural member.

In some examples, the composite part further has a second structural member.

In some examples, the composite threads are located at the intersection of the first structural member and the second structural member.

In some examples, the composite part further has a third structural member.

In some examples, the composite threads are located at the intersection of the first, second and third structural members.

In some examples, the composite material is carbon fiber.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 shows a perspective view of an example integrally threaded composite bottom bracket, in accordance with an example embodiment;

FIG. 2 shows a magnified view of section A of the bottom bracket of FIG. 1;

FIG. 3 shows a partial perspective view of the bottom bracket of FIG. 1 cut along line B-B;

FIG. 4 shows a perspective view of a bottom bracket, in accordance with another example embodiment;

FIG. 5 shows a partial perspective view of the bottom bracket of FIG. 4 cut along line C-C;

FIG. 6 shows a cross-sectional view of the bottom bracket of FIG. 4 along line C-C;

FIG. 7A shows a top view of an alloy spacer in accordance with an example embodiment;

FIG. 7B shows a perspective view of the alloy spacer of FIG. 7A;

FIG. 8 shows a perspective view of a complete bottom bracket mold for manufacturing a bottom bracket, in accordance with an example embodiment;

FIG. 9 shows a top view of half of a bottom bracket mold for manufacturing a bottom bracket, in accordance with an example embodiment;

FIG. 10 shows a top view of half of a bottom bracket mold for manufacturing a bottom bracket, in accordance with an example embodiment;

FIG. 11 shows a perspective view of half of the bottom bracket mold of FIG. 9;

FIG. 12 shows a perspective view of half of a bottom bracket mold and corresponding molded bottom bracket, in accordance with an example embodiment; and

FIG. 13 shows a flowchart of a method of manufacturing a bottom bracket, in accordance with an example embodiment.

The drawings included herewith are for illustrating various examples of articles, systems, and methods of the teachings of the preset specification and are not intended to limit the scope of what is taught in any way. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps, or omitted for repeating instances of like features.

### DESCRIPTION OF EXAMPLE EMBODIMENTS

Various apparatuses will be described below to provide an example of one or more embodiments. No embodiment described below limits any claims and any claims may cover apparatuses that differ from those described below. The claims are not limited to apparatuses, methods or systems having all of the features of any one apparatus, method, or system described below or to features common to multiple or all of the apparatuses, methods and systems described below.

It is possible that an apparatus, system or method described herein is not an embodiment of any claim. Any embodiment disclosed herein that is not claimed in this document may be the subject matter of another protective instrument, for example, a continuing patent application, and the applicants, inventors or owners do not intend to abandon, disclaim or dedicate to the public any such embodiment merely by its disclosure in this document.

The terms “including”, “comprising”, and variations thereof mean “including but not limited to”, unless expressly specified otherwise. A listing of items does not imply that any or all of the items are mutually exclusive, unless expressly specified otherwise. The terms “a”, “an”, and “the” mean “one or more”, unless expressly specified otherwise.

As used herein and in the claims, two or more parts are said to be “coupled”, “connected”, “attached”, “mounted” or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. As used herein, two or more parts are said to be “rigidly coupled”, “rigidly connected”, “rigidly attached”, or “rigidly fastened” where the parts are coupled so as to move as one while maintaining a constant orientation relative to each other. None of the terms “coupled”, “connected”, “attached”, “mounted”, and “fastened” distinguish the manner in which two or more parts are joined together.

Some elements herein may be identified by a part number, which is composed of a base number followed by an alphabetical or subscript-numerical suffix (e.g., 112a, or 1121). Multiple elements herein may be identified by part numbers that share a base number in common and that differ by their suffixes (e.g., 1121, 1122, and 1123). Elements with a common base number may in some cases be referred to collectively or generically using the base number without a suffix (e.g., 112).

It should be noted that terms of degree such as “substantially”, “about”, and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

It should also be noted that, as used herein, the wording “and/or” is intended to represent an inclusive-or. That is, “X and/or Y” is intended to mean X or Y or both X and Y, for example. As a further example, “X, Y, and/or Z” is intended to mean X or Y or Z or any combination thereof of X, Y, and Z.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

### General Description

In some examples, similar references may be used in different figures to denote similar components. In some examples, like features may only be labeled in one instance for simplicity and clarity of the drawings.

The use of composite materials, including carbon fiber, for bike frames is common within the bicycle manufacturing industry. Composite materials allow for the bike frames to be designed with unique tube profiles when compared to other materials, while improving the bike's weight and strength, thereby improving the rider's performance. However, these composite bike frames have limitations. For example, bottom brackets of the composite bike frames require a threaded insert to be installed within the smooth bore of the bottom bracket of the bike, such as a bearing, or a bearing and a carrier shell. This metal bearing, typically manufactured from aluminum, can cause corrosion and/or delamination between the threaded metal bearing and the composite bottom bracket. Further, it is common for users to experience a creaking noise emanating from a specific point with their pedal stroke. This may result from difficulty in controlling geometric tolerances between a threaded metal insert with the composite it is bonded to, and/or with bearings and the metal insert. Similarly, it is difficult to control the alignment of thread-making machinery in subsequent processes. In each instance, there can be tolerance issues due to, but not limited to, concentricity, width, and co-axiality. To prevent this noise, users may remove the metal bearing and generously apply grease prior to re-installation of the metal bearing. This is a temporary fix and may even make the issue worse over time.

Accordingly, an alternative to traditional bottom bracket construction where the bottom bracket is directly manufactured into the primary structure is desired. The various embodiments described herein generally relate to integrally threaded composite bottom brackets for bike frames, and methods of manufacturing the same. The bottom brackets can incorporate composite threading and seek to overcome the issues with traditional composite bike frames. Specifically, the integrally threaded composite bottom brackets prevent corrosion between the would be threaded alloy sleeve and the composite bike frame, as well as provide direct coupling between the structure of the bottom bracket and the threads. Further, the integrally molded threads allow for direct control of meaningful geometric tolerances between the part and threaded interface.

### Integrally Threaded Bottom Bracket

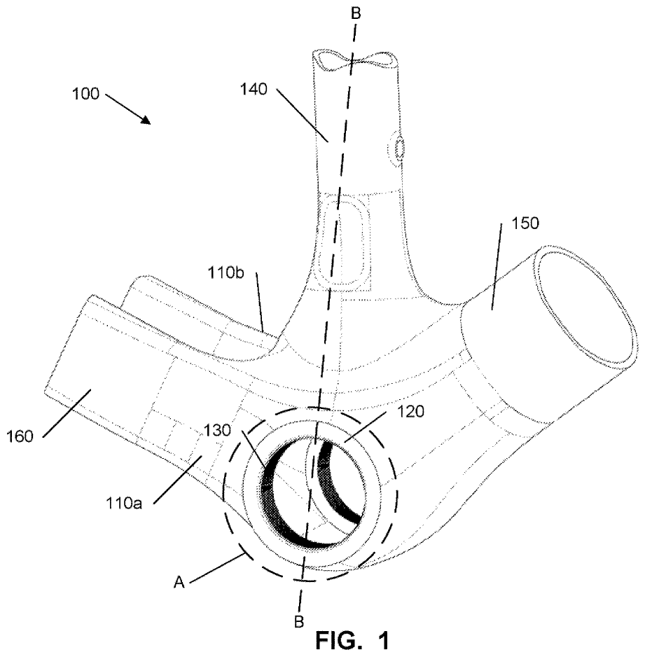

Reference is now made to FIG. 1, which illustrates an example integrally threaded bottom bracket 100, in accordance with an example embodiment. In general, the integrally threaded bottom bracket 100 will provide a support for a pedal mechanism that can provide a source of motive power from the user to the bicycle. The integrally threaded bottom bracket 100 may be a bottom bracket frame for a two wheeled bicycle, and can define a traditionally shaped bottom bracket, having a first component 140, a second component 150, and a third component 160 joining together around an inner bore 120, as illustrated in FIG. 1. However, alternative frame compositions may be employed in accordance with the disclosed invention.

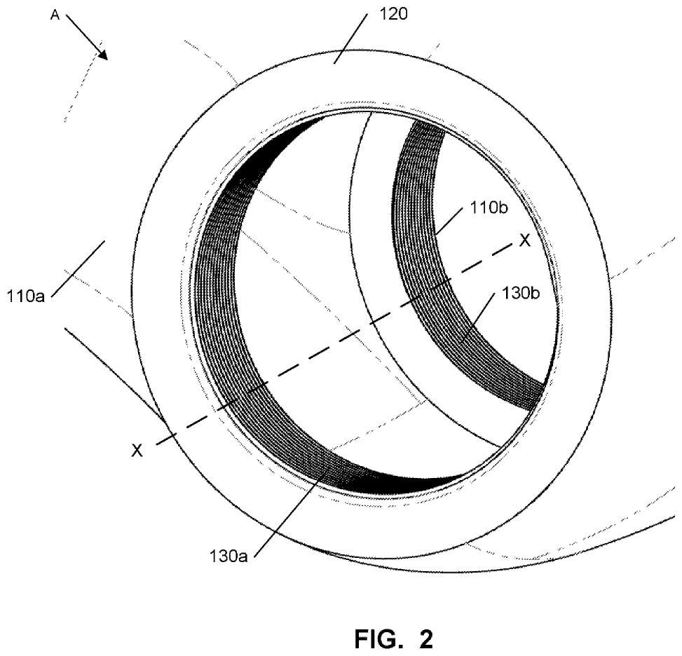

The integrally threaded bottom bracket 100 includes a top surface 110a defining a first plane, a bottom surface 100b defining a second plane, and the inner bore 120 extending through the integrally threaded bottom bracket 100 from the top surface 110 to the bottom surface along a bore axis X-X (illustrated in FIG. 2). Axis X-X defines a central axis through the midpoint of the inner bore 120. The inner bore 120 contains composite threading 130 along the interior surface of the inner bore 120. The inner bore 120 of the integrally threaded bottom bracket 100 may serve to support the crank axle of the pedals of the bike.

In accordance with the disclosed invention, the respective integrally threaded bottom bracket 100 is formed from non-metallic synthetic resins reinforced with structural fibers. In some embodiments, the integrally threaded bottom bracket 100 is composed of a composite material. In some embodiments, the integrally threaded bottom bracket 100 is composed of carbon, or similarly structured fiber reinforcement. Further discussion of the manufacturing process of the integrally threaded bottom bracket 100 will be included below.

Referring still to FIG. 1, it is illustrated that the first component 140 and the second component 150 may be hollow, tubular members. The third component 160 may be of a U-shape, the U-shape extending along the top surface 110a of the integrally threaded bottom bracket 100, around the inner bore 120 and back along the bottom surface 110b of the integrally threaded bottom bracket 100. In some embodiments, the third component 160 may have an additional surface on either side to connect the top surface 110a to the bottom surface 110b of the third component 160. In some embodiments, the third component 160 may be of a hollow, tubular shape. In some embodiments, the first component 140 and the second component 150 may include two rectangular members defining a structure similar to that of the illustrated third component 160.

As illustrated, first component 140, second component 150 and third component 160 are connected at a junction surrounding the inner bore 120. Each of the first, second and third components 140, 150, 160 are located along an independent axis. For example, the first component 140 extends along a first axis, the second component 150 extends along a second axis different to the first axis, and the third component 150 extends along a third axis different to each of the first and second axes. The inner bore 120 is located at the collision point of the first axis, second axis and third axis. Each of the first, second and third axes are defined along the same plane.

The first component 140, second component 150 and third component 160 are each single walled structural members. The walls of each of the first, second and third components 140, 150 160 may be of a thickness of anywhere between 0.2 mm and 8.0 mm. In some embodiments, the walls may have a thickness of anywhere between 0.1 mm and 10.0 mm. In some embodiments, the walls may have a thickness of anywhere between 0.1 mm and 12.0 mm. In other embodiments, the walls may be of any thickness suitable for the application.

In some embodiments, bottom bracket 100 may include two components connecting at a junction surrounding the inner bore 120. In some embodiments, bottom bracket 100 may include a single component having an inner bore 120 extending from the top surface 110a to the bottom surface 110b of the single component. In other embodiments, the bottom bracket 100 may have any configuration and/or number of components with an inner bore 120.

Referring now to FIG. 2, shown therein is a magnified view of section A of FIG. 1, illustrating the inner bore 120 in further detail. As shown, inner bore 120 of the integrally threaded bottom bracket 100 includes composite threading 130 along the top surface 110a and the bottom surface 110b. The inner bore 120 extends between the top surface 110a and the bottom surface 110b, the distance between which is a predetermined depth. Inner bore 120 of the integrally threaded bottom bracket 100 may be within a dimension range of anywhere between 25 mm and 60 mm. In some embodiments, the inner bore 120 may have a depth of anywhere between 15 mm and 70 mm. In some embodiments, the inner bore 120 may have a depth of anywhere between 10 mm and 75 mm. In other embodiments, the inner bore 120 may have any depth as suitable for the application.

The first composite threading 130a of inner bore 120 may extend from the top surface 110a towards the bottom surface 110b along bore axis X-X a distance equal to that of the depth of the walls of any of the adjoining components 140, 150, 160. The second composite threading 130b of inner bore 120 may, as shown in FIG. 2, extend from the bottom surface 110b towards the top surface 110b along bore axis X-X a distance equal to that of the depth of the walls of any of the adjoining components 140, 150, 160.

In some embodiments, the first composite threading 130a may extend from the top surface 110a towards the bottom surface 110b along bore axis X-X a distance greater than the depth of the walls of any of the adjoining components 140, 150, 160. In some embodiments, the composite threading 130 may extend the full distance between the top surface 110a and the bottom surface 110b. In some embodiments, the first and second composite threading 130a, 130b may extend along bore axis X-X for a distance of anywhere between 1 mm and 30 mm. In some embodiments, the composite threading 130a, 130b may have a depth of 0.5 mm to 35 mm. In some embodiments, the composite threading 130a, 130b may have a depth of 0.2 mm to 40 mm. In other embodiments, the composite threading 130a, 130b may be of any depth as is suitable for the application.

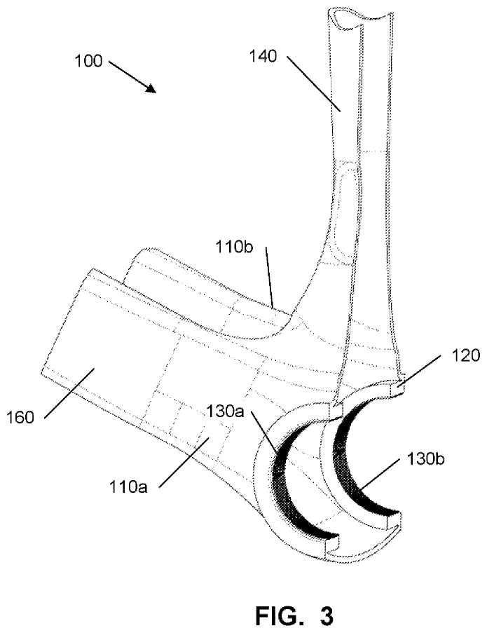

Referring now to FIG. 3, shown therein is a partial perspective view of the integrally threaded bottom bracket 100 cut along line B-B of FIG. 1. As illustrated in FIG. 3, the first composite threading 130a may extend from the top surface 110a towards the bottom surface 110b a distance greater than the depth of the walls of any of the adjoining components 140, 150, 160.

### Method of Manufacturing Integrally Threaded Bottom Bracket

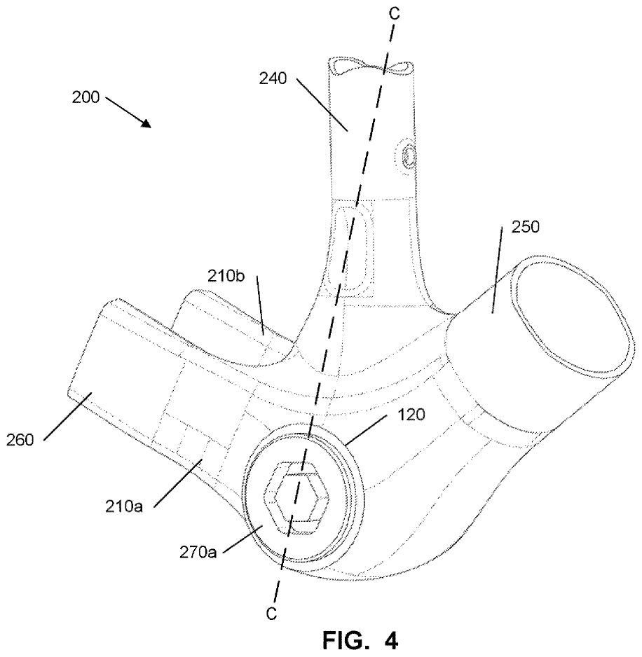

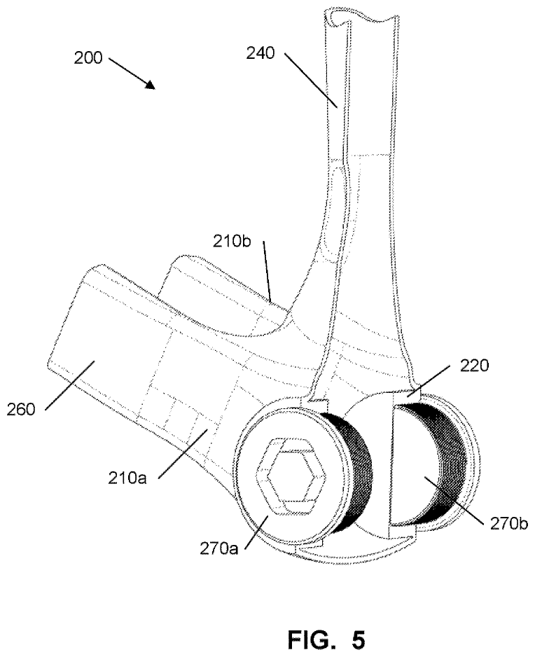

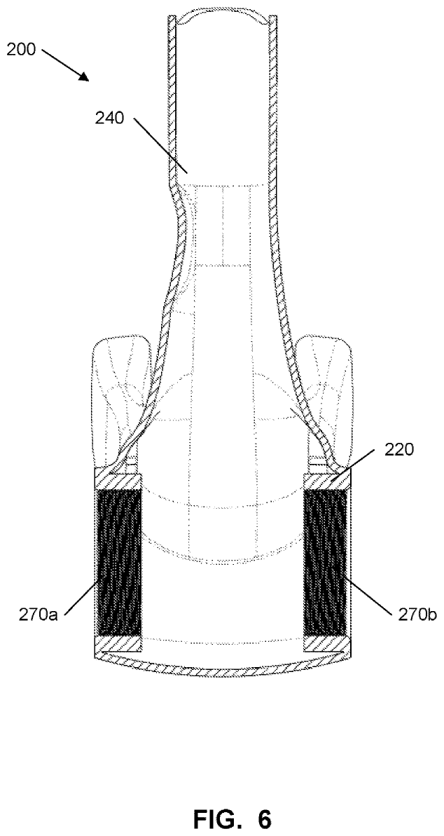

Reference will now be made to FIGS. 4 to 6. FIG. 4 shows another example integrally threaded bottom bracket 200. Integrally threaded bottom bracket 200 is substantially similar to integrally threaded bottom bracket 100 as described in FIGS. 1 to 3. FIG. 5 shows a partial perspective view of the integrally threaded bottom bracket 200 cut along line C-C of FIG. 4. FIG. 6 shows a cross-sectional view of the integrally threaded bottom bracket 200 along line C-C of FIG. 4.

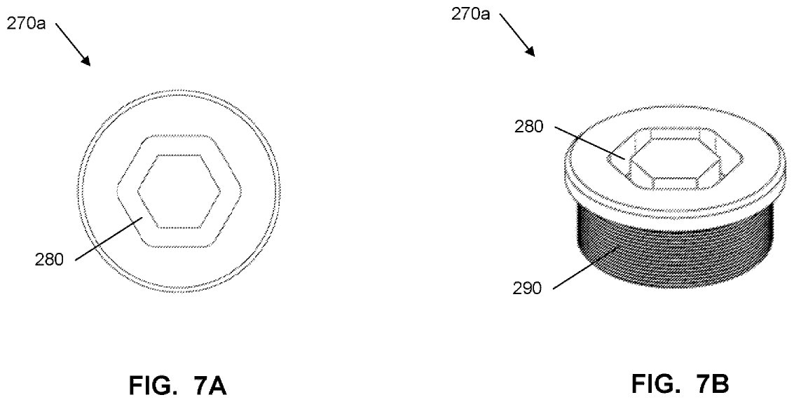

FIG. 4 shows integrally threaded bottom bracket 200 in a state after molding. Located within inner bore 220 of integrally threaded bottom bracket 200 is a molding insert 270a. Molding insert 270a is shown in further detail in FIGS. 7A and 7B. In some embodiments, as shown in FIG. 4, a single molding insert 270a may be used to achieve the integrally threaded bottom bracket 200. Referring now to FIGS. 5 and 6, two molding inserts 270a, 270b are shown located within inner bore 220 of integrally threaded bottom bracket 200. In other embodiments, as shown in FIGS. 5 and 6, two molding inserts 270a, 270b may be used to achieve the integrally threaded bottom bracket 200. In other embodiments, various insert methodologies may be used to achieve integrally threaded bottom brackets 200.

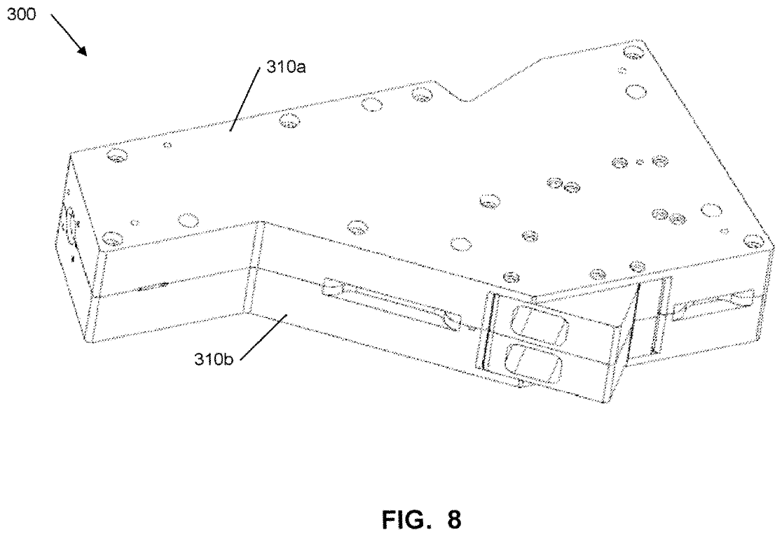

Referring now to FIGS. 7A and 7B, shown are a top view and side view, respectively, of example molding insert 270a. Molding insert 270a may be a cylindrical shape and include a top 280 and a bottom 290. The top 280, as shown in FIG. 7A, may have a component that is interfaceable by a manufacturer. For example, as shown, top 280 may include an indentation able to receive a tool to enable the molding insert 270a to be handled by the user and located precisely within a main part mold (as shown in FIGS. 8 to 12. In some embodiments, top 280 may allow for interaction between the molding insert 270a and a hex key, a screwdriver, a wrench, or any other tool. Bottom 290 of molding insert 270a includes a threaded geometry. The threaded geometry may be of any orientation, depth and thickness as desired.

In some embodiments, molding insert 270a may be designed to include reservoirs, galleries, flutes, reliefs, grooves, or valleys within the composite threading to prevent dirt that may have accumulated within the thread from binding or gulling the thread. This may allow easier removal and/or repair of the bearing cartridges of the bike. This further decreases the chances of bearing noises, bearing cartridge seizing, or unnecessary wear and tear on the thread surfaces.

Referring now to FIG. 8, shown therein is a tool assembly 300 according to an example embodiment. Tool assembly 300 may include a top part mold 310a and a bottom part mold 310b. The part molds 310a, 310b may be shaped to form the bottom bracket as disclosed above.

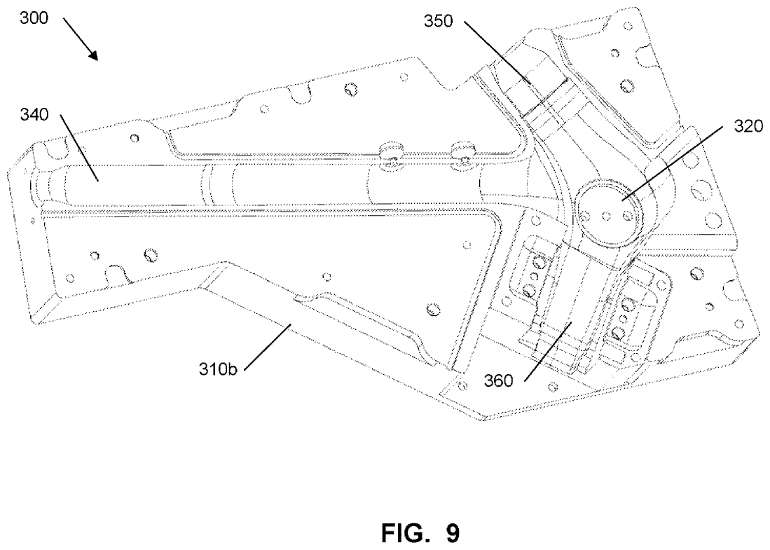

Referring now to FIG. 9, shown therein is a top view of the bottom frame mold 310b of tool assembly 300. Frame mold 310b may provide space for the bottom bracket to be formed within. As shown in FIG. 9, the first component 140 of integrally threaded bottom bracket 100 (discussed in relation to FIGS. 1 to 3) may be molded within first component mold 340 of the tool assembly 300. Further, the second component 150 of integrally threaded bottom bracket 100 (discussed in relation to FIGS. 1 to 3) may be molded within second component mold 350 of the tool assembly 300 and the third component 160 of integrally threaded bottom bracket 100 (discussed in relation to FIGS. 1 to 3) may be molded within third component mold 360 of the tool assembly 300.

Further shown in FIG. 9 is an inner bore locating feature 320 for accepting insert 270A to mold the inner bore 120 of integrally threaded bottom bracket 100 (discussed in relation to FIGS. 1 to 3).

In some embodiments, additional components not shown in FIGS. 9 to 11 may be included within the tool assembly 300 to alter the geometry or shaping of the tubes of the bottom bracket. For example, as noted in discussions of the third component 160 of integrally threaded bottom bracket 100, the third component 160 may be of a U-shape. As such, tool assembly 300 may include an additional frame component to encourage the third component 360 into the desired U-shape.

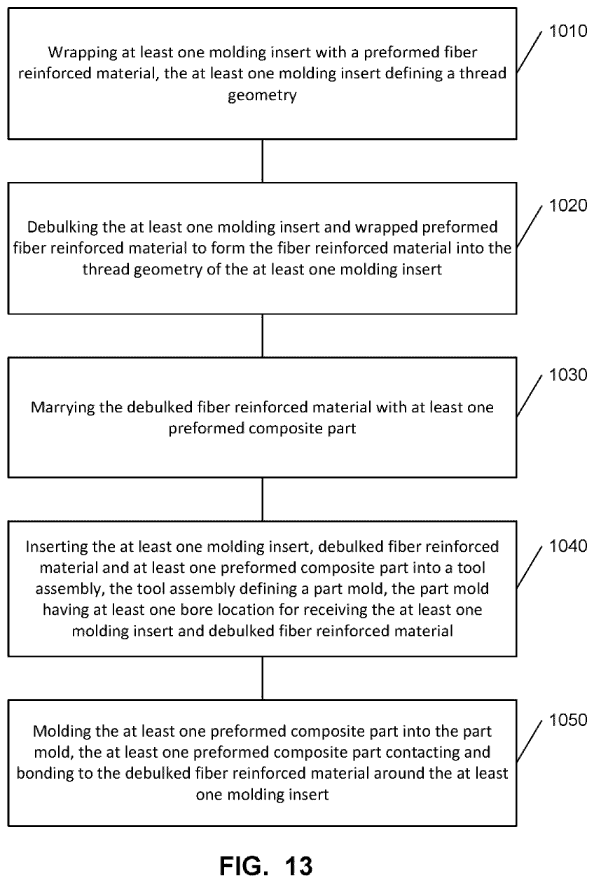

Reference will now be made to FIG. 13, which shows a flowchart of an example method 1000 for assembling a system of modular structural panels. To assist with the description of the method 1000, reference will be made simultaneously to FIGS. 7 to 12.

At step 1010, at least one molding insert 270a is wrapped in at least one layer of composite to create the composite threads. In some embodiments, molding insert 270a may be wrapped in more than one layer of composite. In some embodiments, the layer of composite wrapped around the at least one molding insert 270a may be a dry fiber reinforcement. In said embodiment, a spray adhesive may be applied to the at least one molding insert 270a prior to wrapping the dry fiber reinforcement around the at least one molding insert 270a. In some embodiments, the layer of composite may be a resin-injected fiber reinforcement or a pre-impregnated material.

At step 1020, molding insert 270a and pre-impregnated wrapped composite are then debulked to form the composite into the threaded geometry of the molding insert 270a. The process of debulking may include placing the molding insert 270a and wrapped composite inside a vacuum sealable bag and vacuum sealing the bag with the molding insert 270a and composite inside. This process of vacuum sealing the composite onto the molding insert 270a may allow the composite to mold around the threaded geometry of the molding insert 270a, creating threads composed of the composite layers. Debulking the molding insert 270a and wrapped composite may reduce the number of voids within the composite threaded geometry and improve the quality of the composite threads.

In some embodiments, for example when the composite material is a dry fiber reinforcement, once the composite around the molding insert 270a has been debulked, a resin may be applied to the molding insert 270a and wrapped composite to further lay the composite into the threaded geometry of the molding insert 270a. The resin may be applied via a brush, a roller, a spray gun, vacuum injected or any other application method.

At step 1030, the debulked molding insert 270a and corresponding formed composite threads are bonded to the composite preform for the remaining frame structure (not shown).

The preform composite frame may be formed by laminating layers of composite material around a mandrel. The mandrel may include a bladder filled with glass beads. In some embodiments, the bladders may be formed of a latex or other elastic material. In other embodiments, the bladders may be made of a thermoplastic tube or film-like material. In some embodiments, the bladders may be formed of a bio-degradable material. In some embodiments, the bladders may be of a round or cylindrical shape. In some embodiments, the bladders may be complex shapes resembling the final geometry of the part to be manufactured. In some embodiments, a silicone or other solid elastomeric material with high thermal expansion may be used to apply or intensify pressure.

In some embodiments, multiple bladders and/or other pressure-supplying media are required for each element of the desired shape. For example, in FIGS. 9 to 11, one bladder would be required for the first component mold 350, another bladder would be required for the second component mold 350, and an additional bladder would be required within the third component mold 360 to form the third component 160.

In some embodiments, after the bladder is filled with glass beads to create a mandrel, the composite material may be laminated around the mandrel to form a composite preform for the remaining part structure. The composite preform may have the approximate size and shape of the final desired part. Once the composite preform has been laminated around the mandrel, the glass beads may be removed from the bladder, Returning to step 1030, the debulked molding insert 270a and corresponding formed composite threads are joined to the composite preform of the remaining frame structure. The debuiked molding insert 270a is wrapped in a draping ply. The draping ply may be a single layer of composite material wrapped around the debulked molding insert 270a. The draping ply may then be removably married to the laminated composite preform for the remaining frame structure. The removable marriage between the draping ply and the composite preform may be through compressing the materials together, applying an adhesive spray, applying heat, or any other technique as known in the art to removably adjoin two composite materials.

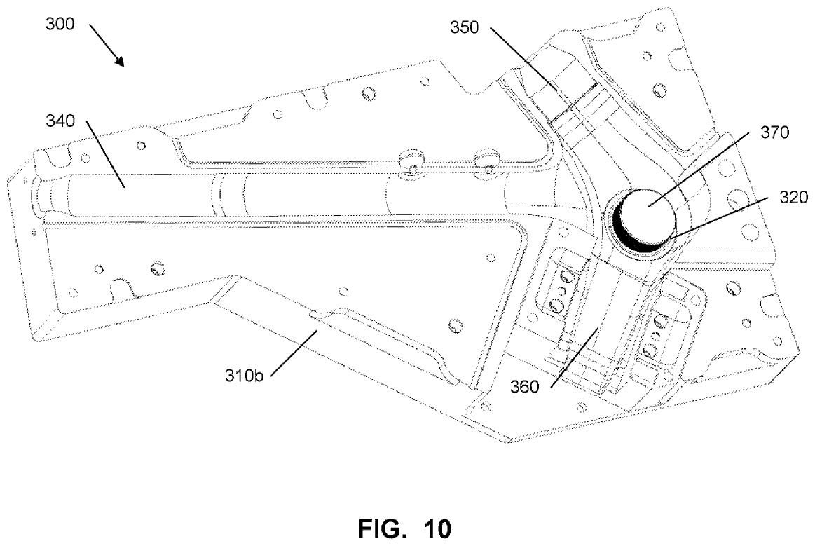

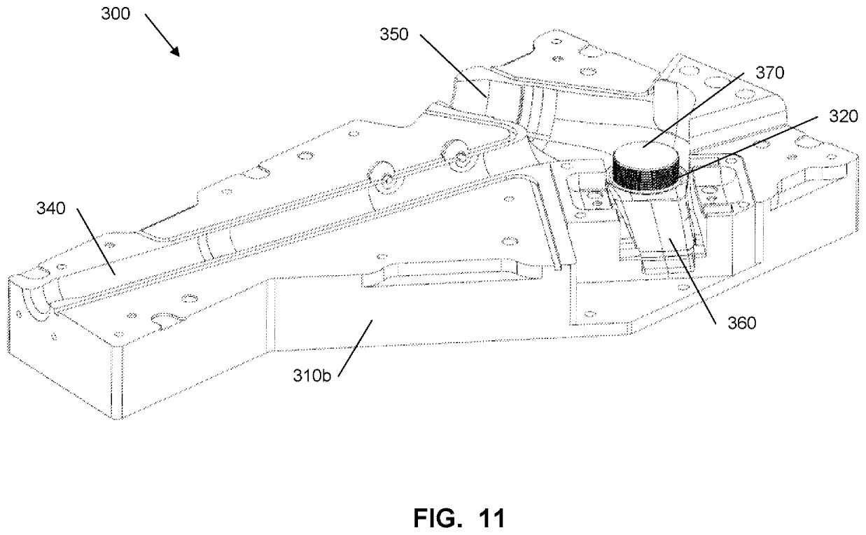

At step 1040, the molding insert 270a and formed composite threads are inserted into tool assembly 300, shown in FIGS. 10 and 11. In some embodiments, the composite preform for the remaining frame structure are inserted into the tool assembly 300 at the same time as the molding insert 270a and formed composite threads. The tool assembly 300, as disclosed, may define a part mold of a bottom bracket of a bicycle. In some embodiments, the tool assembly 300 may define a part mold for any part including an integrally threaded component. The part mold 310a, 310b has at least one bore locating feature 320 for the at least one molding insert 270a and formed composite threads. In the embodiment shown in FIGS. 10 and 11, the molding insert 270a is placed within the part mold 310b at the inner bore locating feature 320. This insertion of the molding insert 270a into the inner bore locating feature 320 of the tool assembly 300 may allow for additional control of the tolerances of the threaded geometry in conjunction with the additional frame components.

In some embodiments, two molding inserts 270a and 270b (not shown) may be included within the tool assembly 300. As shown, molding insert 270a may be placed within the inner bore locating feature 320 of the bottom part mold 310b, while molding insert 270b may be placed within an inner bore locating feature (not shown) of the top part mold 310a. The molding inserts 270a, 270b may have lengths that, when combined, are less than or equal to the total distance from the top part mold 310a to the bottom part mold 310b. In such an embodiment, there may be a space remaining between molding insert 270a and molding insert 270b during manufacture. In some embodiments, a single molding insert 270a may be included within the tool assembly 300.

Once the frame components have been placed within the tool assembly 300, the part molds 310a, 310b may be placed in a closed configuration, as shown in FIG. 8, and fastened together.

Referring back to FIG. 13, at step 1050, the composite layup is molded into the part mold 310a, 310b, solidifying the marriage between the preformed composite and the composite threads.

The method of molding the preformed composite into the frame may include inflating the bladder within the tool assembly 300, which may have been wrapped in the preformed composite. An air hose may be attached to a bladder input of the tool assembly 300. Air may then be input into the bladder within the tool assembly 300 to inflate the bladder. The inflation of the bladder may push the preformed composite into the interior surface of the top and bottom part molds 310a, 310b. This inflation may force the composite material to conform to the shape of the top and bottom part molds 310a, 310b, thereby creating the desired shape.

During molding, the tool assembly 300 may be heated and pressurized to form the composite preform to the top and bottom part molds 310a, 310b. The combination of the inflation of the bladder, activation of the tool assembly 300, and corresponding composite preform, by heating or otherwise, may encourage the composite preform into contact with the formed composite threads.

In one embodiment, where the molding inserts 270a, 270b do not reach through the depth of the tool assembly 300, the composite may fill the space left between the molding inserts 270a, 270b and the bladder to create a thin layer of composite within the inner bore. In another embodiment, the molding inserts 270a, 270b reach through the full depth of the tool assembly 300, thus leaving no room for additional composite to fill between. In yet another embodiment, molding inserts 270a, 270b may be a single piece extending through the depth of the tool assembly 300, again leaving no room for additional composite to fill between.

In some embodiments, the tool assembly 300 may be heated to a degree of approximately 120 degrees Celsius during the molding stage. In some embodiments, the tool assembly 300 may be heated to a degree of anywhere between 100 and 150 degrees Celsius. In some embodiments, the tool assembly 300 may be heated to a range dependent on the material and/or resin used for the frame.

In some embodiments, the tool assembly 300 may be pressurized to a pressure of approximately 200 psi during the molding stage. In some embodiments, the tool assembly 300 may be pressurized to a pressure of anywhere between 150psi and 250psi during the molding stage. In some embodiments, the tool assembly 300 may be pressurized to a pressure dependent on the material and/or resin used in the frame.

In some embodiments, the tool assembly 300 may be clamped in the closed configuration during molding at a pressure of anywhere between 15 and 20 tons. In some embodiments, the tool assembly 300 may be clamped in the closed configuration during molding at a pressure of anywhere between 10 and 25 tons. In some embodiments, the tool assembly 300 may be clamped in the closed configuration during molding at a pressure dependent on the material and/or resin used in the frame.

In some embodiments, the bottom bracket 100 may be cured prior to removal from the tool assembly 300, during the heat and pressure cycle as disclosed. The curing of the bottom bracket 100 may occur while the part is within the tooling assembly 300, and the tooling assembly is within a heated press. The bottom bracket 100 may cure for a time period of two hours prior to removal from the tool assembly 300. In some embodiments, the bottom bracket 100 may cure for a time period of anywhere between one hour and three hours. In some embodiments, the bottom bracket 100 may cure for any amount of time dependent on the resin and/or material used.

In some embodiments, the bottom bracket 100 may be cured at a temperature between 100 and 150 degrees Celsius. In some embodiments. The bottom bracket 100 may be cured at a temperature between 50 and 300 degrees Celsius, In some embodiments, the bottom bracket 100 may be cured at a temperature dependent on the resin and/or material used.

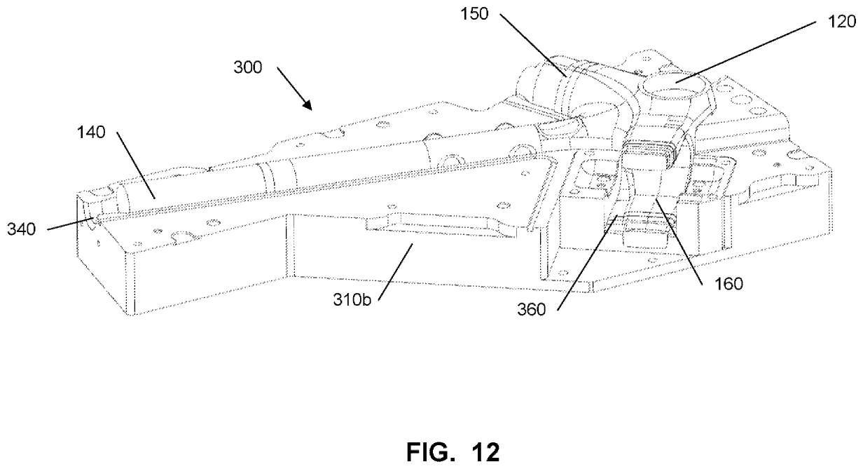

Referring now to FIG. 12, shown therein is a formed bottom bracket with composite internal threading. The bottom bracket 100 is numbered to correspond to the bottom bracket shown in FIGS. 1 to 3.

Once the composite layup has been bonded to the formed composite threads and cured, the fully formed bottom bracket 100 may be left to cool, and then removed from the tool assembly 300. The tool assembly 300 and corresponding part may be cooled to remove the shock factor and allow for handleability of both the tool assembly 300 and the corresponding part.

After curing of the bottom bracket 100, in some embodiments, the bladder or multiple bladders used within the molding process may be removed from the components prior to the assembly of the bottom bracket 100 with the remaining elements of the bicycle. In some embodiments, where the bladders are manufactured of a biodegradable material, the bladders may remain within the bottom bracket 100 after curing and may remain within the frame of the bicycle once fully assembled.

In some embodiments, where the molding inserts 270a, 270b did not reach through the depth of the tool assembly 300, the composite layer formed between the two inserts and the bladder may have created a thin layer of composite within the inner bore 120 between the molding inserts 270a, 270b. In such embodiment, the thin layer of composite may be removed from the inner bore 120. This removal may occur prior to or after the curing process has taken place. The removal of the composite layer may occur prior to assembly of the remaining bicycle frame with the bottom bracket 100.

In some embodiments, the bottom bracket 100 is designed to work with an alloy spacer to be inserted between the composite threading 130 on the inner bore 120 and the bearing cartridge. In some embodiments, the alloy spacer is made from a gasket type material. In some embodiments, the alloy spacer includes an integrated O-ring to remove the possibility of dirt entering the composite threading 130.

In some embodiments, the bottom bracket 100 may be treated with a ceramic coating. In some embodiments, the ceramic coating applied to the bottom bracket 100 may be Cerakote®. In some embodiments, the composite threading 130 is treated with the ceramic coating. The ceramic coating may increase the hardness of the composite material and composite threading of the frame.

The embodiments described herein provide an improved, integrally threaded composite bottom bracket for a bicycle frame. It is noted that this composite frame may solve the difficulties experienced by users and reduce failure modes or problem sites, as the tolerances of the threads and concentricity of the bearings may be more easily controlled based on the molding inserts 270.

A further advantage to the aforementioned embodiments includes improving the longevity of the bearings in the bottom bracket. The threaded surface may have some imperfections from the molding process, including in the form of voids or gaps within the threading. This may act as a reservoir, gallery, flute, relief, groove, or valley within the composite threading to prevent dirt that may have accumulated within the thread from binding or gulling the thread. In traditional bike frames, dirt may occupy the area between the threaded bearing cartridge and the threading on the bottom bracket of the bike. This packing of dirt between the cartridge and the threading may make removal of the bearing cartridge difficult or almost impossible. In addition, it creates an abrasive between the bottom bracket and the bearings that can deteriorate both materials over time. In contrast, the reservoirs within the composite threading may give the dirt a place to sit without being directly between the threads and the cartridge, thereby allowing for easier disassembly and a potentially longer service life.

Various embodiments have been described herein by way of example only. Various modifications and variations may be made to these example embodiments without departing from the spirit and scope of the invention, which is limited only by the appended claims.

1. A composite integrally threaded part comprising:
a first structural member extending along a first plane;
a second structural member extending along the first plane;
a hollow inner bore located at an intersection of the first and second structural members, the hollow inner bore extending perpendicularly to the first plane; and
at least one composite thread located along the interior of the hollow inner bore and integrally formed therewith.

2. A composite bottom bracket for a bicycle frame comprising:
a first structural member extending along a frame plane and defining a first surface and a second surface;
a second structural member extending outwardly from the first structural member along the frame plane, the second structural member continuously defining the first surface and the second surface;
a third structural member extending outwardly from each the first and second structural members along the frame plane, the third structural member continuously defining the first surface and the second surface;
a hollow inner bore located at an intersection of the first, second and third structural members, the hollow inner bore extending from the first surface to the second surface; and
composite threads located along the interior of the hollow inner bore,
wherein the composite threads extend from the first surface into the inner bore and extend from the second surface into the inner bore and are integrally formed therewith.

3. The composite bottom bracket of claim 2, wherein the hollow inner bore is adapted to operationally receive a pedal mechanism.

4. The composite bottom bracket of claim 1, wherein each of the first, second and third structural members have a wall depth of 0.2 mm and 8.0 mm.

5. The composite bottom bracket of claim 4, wherein the composite threads extend from each the first surface and the second surface into the inner bore along the bore axis a distance greater than the single wall depth.

6. The composite bottom bracket of claim 5, wherein the composite threads extend from the first surface to the second surface.

7. The composite bottom bracket of claim 2, wherein the first, second and third structural members are single walled hollow structural members.

8. The composite bottom bracket of claim 2, wherein the first structural member extends along a first axis, the second structural member extends along a second axis, and the third structural member extends along a third axis.

9. The composite bottom bracket of claim 8, wherein the hollow inner bore is located at an intersection of the first axis, the second axis, and the third axis.

10. A method of manufacturing an integrally threaded composite part, the method comprising:
wrapping at least one molding insert with a preformed fiber reinforced material, the at least one molding insert defining a thread geometry;
debulking the at least one molding insert and wrapped preformed fiber reinforced material to form the fiber reinforced material into the thread geometry of the at least one molding insert;
marrying the debulked fiber reinforced material with at least one preformed composite part;
inserting the at least one molding insert, debulked fiber reinforced material and at least one preformed composite part into a tool assembly, the tool assembly defining a part mold, the part mold having at least one bore location for receiving the at least one molding insert and debulked fiber reinforced material; and
molding the at least one preformed composite part into the part mold, the at least one preformed composite part contacting and bonding to the debulked fiber reinforced material around the at least one molding insert.

11. The method of claim 10, further comprising assembling at least one preformed composite part prior to marrying the debulked fiber reinforced material, the assembly including wrapping at least one mandrel with at least one preformed composite material.

12. The method of claim 11, wherein the debulked fiber reinforced material around the at least one molding insert is married to the at least one preformed composite part by a draping ply, the draping ply placed around the debulked fiber reinforced material and bonded to the at least one preformed composite part.

13. The method of claim 10, wherein molding the at least one preformed composite part comprises:
inflating at least one bladder to push the at least one preformed composite part into the part mold; and
applying heat, a clamping force to the part mold and internal pressure to the at least one bladder.

14. The method of claim 13, wherein molding the at least one preformed composite part further comprises curing the at least one preformed composite part within the part mold.

15. The method of claim 14, wherein after curing the at least one preformed composite part within the part mold, the integrally threaded composite part is cooled and removed from the part mold.

16. The method of claim 14, wherein the integrally threaded composite frame is cured for one to three hours at a temperature of 100 to 150 degrees Celsius.

17. The method of claim 14, wherein after curing, the at least one bladder is removed from the interior of the integrally threaded composite part.

18. The method of claim 13, wherein the at least one bladder is formed of a bio-degradable material.

19. The method of claim 13, wherein the at least one bladder is of a complex shape resembling the final geometry of the part mold.

20. The method of claim 10, wherein the part mold is shaped to form a bottom bracket comprising:
a first structural member extending along a first plane;
a second structural member extending along the first plane; and
a hollow inner bore located at an intersection of the first and second structural members, the hollow inner bore extending perpendicularly to the first plane.

21. The method of claim 10, wherein the part mold is shaped to form a part comprising:
a first structural member extending along a frame plane and defining a first surface and a second surface;
a second structural member extending outwardly from the first structural member along the frame plane, the second structural member continuously defining the first surface and the second surface;
a third structural member extending outwardly from each the first and second structural members along the frame plane, the third structural member continuously defining the first surface and the second surface; and
a hollow inner bore located at an intersection of the first, second and third structural members, the hollow inner bore extending from the first surface to the second surface.

22. The method of claim 21, wherein the at least one molding insert and formed composite threads are inserted within the hollow inner bore locating feature of the part mold.

23. The method of claim 22, wherein the at least one molding insert and formed composite threads extend from the first surface to the second surface.

24. The method of claim 21, wherein at least two molding inserts and formed composite threads are inserted within the hollow inner bore locating feature of the part mold, the first molding insert located at the first surface and the second molding insert located at the second surface.

25. The method of claim 24, wherein a space is formed between the at least two molding inserts within the hollow inner bore locating feature, the space laminated through to form a solid bore of composite material.

26. The method of claim 25, wherein the composite material filling the space between the at least two molding inserts is removed.

27. The method of claim 25, wherein the composite material filling the space between the at least two molding inserts is not removed.

28. A bicycle comprising:
a frame having at least one frame member made of a composite material; and
at least one composite thread located within the at least one frame member and being integrally formed therewith.

29. The bicycle of claim 28, wherein the at least one composite frame member is located along a crank axis and supports a pedal mechanism.

30. The bicycle of claim 28, wherein the frame comprises at least two frame members made of composite material.

31. The bicycle of claim 30, wherein the at least one composite thread is located at the intersection of the at least two frame members.

32. The bicycle of claim 28, wherein the frame comprises at least three frame members made of composite material.

33. The bicycle of claim 32, wherein the at least one composite thread is located at the intersection of the at least three frame members.

34. A frame for a vehicle, comprising:
at least one frame member made of a composite material; and
at least one composite thread located within the at least one frame member and being integrally formed therewith.

35. The frame of claim 34, wherein the vehicle is a bicycle.

36. The frame of claim 35, wherein the at least one composite frame member is located along a crank axis and supports a pedal mechanism.

37. The frame of claim 34, wherein the at least one composite thread extends inwardly from an outer surface of the at least one frame member.

38. An integrally threaded composite part comprising:
a first structural member; and
composite threads integrally formed in the structural member and extending inwardly from an outer surface of the structural member.

39. The integrally threaded composite part of claim 38, further comprising a second structural member.

40. The integrally threaded composite part of claim 39, wherein the composite threads are located at the intersection of the first structural member and the second structural member.

41. The integrally threaded composite part of claim 39, further comprising a third structural member.

42. The integrally threaded composite part of claim 41, wherein the composite threads are located at the intersection of the first, second and third structural members.

43. The integrally threaded composite part of claim 38, wherein the composite material is carbon fiber.
